(19) United States
(12) Patent Application Publication
(10) Pub. No.: US 2013/0186821 A1
(43) Pub. Date: Jul. 25, 2013

(54) APPARATUS AND METHOD FOR DE-WATERING OF FLOCCULATED MATERIALS

(71) Applicants: Michael K. Hodges, Colorado Springs, CO (US); Larry D. Campbell, Harrah, CO (US); David L. Fry, Newalla, OK (US)

(72) Inventors: Michael K. Hodges, Colorado Springs, CO (US); Larry D. Campbell, Harrah, CO (US); David L. Fry, Newalla, OK (US)

(73) Assignee: GENESIS FLUID SOLUTIONS, LTD, Colorado Springs, CO (US)

(21) Appl. No.: 13/574,736

(22) PCT Filed: Mar. 4, 2011
(86) PCT No.: PCT/GB2011/000305

§ 371 Date: Feb. 26, 2013

Related U.S. Application Data
(60) Provisional application No. 61/310,832, filed on Mar. 5, 2010.

(51) Int. Cl. B01D 29/00

(52) U.S. Cl. CPC B01D 29/00
USPC 210/416.1

(57) ABSTRACT

An apparatus (1) for de-watering flocculated material, the apparatus comprising a vessel (2) having a first volume and a second volume (7) being separated by a filter means (12), the filter means (12) being configured to allow water to pass through and to retain solids. The first volume (6) being for receiving flocculated material. The apparatus also comprises pressure application means (13) configured, in use, to apply a reduced pressure from a location in the first volume (6) spaced from the filter means (12), the pressure application means (13) being provided with a fluid connection for removal of water from the location in the first volume.

The present invention relates to an apparatus and method for de-watering flocculated material. Such flocculated material may be produced from slurries, for example from dredge spoils, to which a flocculating agent has been added. The flocculated material may, for example, comprise clays, silts and organic matter.

The flocculated material may be the product of a stage of a de-watering process. Such a de-watering process is known from WO2007/093809.

De-watering systems are used to remove water from solid matter so that the solids may be recycled or disposed of. The water removed in the de-watering process may be further treated and/or returned to the environment, e.g. a waterway, or used in further stages of an industrial circuit, as a clear supernatant.

Conventional de-watering systems typically comprise screening assemblies, hydrocyclones, centrifuges, belt presses and clarifying vessels. Such systems may be batch processes of continuous de-watering systems.

Known processes for de-watering flocculated materials have made use of belt presses. In such processes, a pair of tensioned belts are used to apply mechanical pressure to a sludge sandwiched between the belts. Belt presses may provide secondary capillary water removal producing a resultant cake solid. Belt press systems have been successful in creating stackable solids for easy transport and disposal.

However, belt press systems can be a relatively slow in operation. As such, a belt press can be a bottleneck to the very high speed capability of other de-watering components in a system. Further, belt presses can be operationally problematic, due to their many moving parts and variable components. As such, the belt press systems require operators to successfully control and operate them.

Because of their limited capacities, many belt presses may be needed to create sufficient mass balance to match the production from the other components of a system. Such a system therefore has increased complexity and cost. Productivity may therefore also be limited.

As an alternative to belt presses, shallow lift (vacuum bed) de-watering systems have also been used in de-watering flocculated material, for example in the form of a sludge. In such a system, a sludge is poured into a tank or cell with a filter medium for example a porous floor. A vacuum is applied to the sludge through the porous floor, which then draws capillary water from the flocculated material. However, such systems are only suitable for de-watering shallow sludge layers. Even so, as a vacuum is applied to the flocculated material, the floccules may be degraded near the filter medium. The structure of the floccules may also then be destroyed due to the forces of the vacuum. Ultra-fine clays and other organics may be liberated from the matrix of the floccules. These particulates may begin to obstruct passageways in the porous floor for capillary water release and thereby reduce the percolation rates through the depth of the sludge. While initially the de-watering rate may be high, as the passageways become blocked, the de-watering rates may be reduced significantly.

The present invention seeks to overcome or at least ameliorate some of the problems associated with the prior art.

According to a first aspect of the present invention there is provided an apparatus for de-watering flocculated material, the apparatus comprising:
a vessel having a first volume and a second volume being separated by a filter means, the filter means being configured to allow water to pass through and to retain solids;
the first volume being for receiving flocculated material; and
pressure application means configured, in use, to apply a reduced pressure from a location in the first volume spaced from the filter means, the pressure application means being provided with a fluid connection for removal of water from the location in the first volume.

Preferably, the apparatus further comprises pressure reducing means for reducing the pressure in the second volume relative to the first volume. The pressure reducing means may be in the form of a vacuum pump.

According to a second aspect of the present invention, there is provided an apparatus for de-watering flocculated material, the apparatus comprising:
a vessel having a first volume and a second volume being separated by a filter, the filter being configured to allow water to pass through and to retain solids;
the first volume being for receiving flocculated material; and
a pressure application device configured, in use, to apply a reduced pressure from a location in the first volume spaced from the filter, the pressure application device being provided with a fluid connection for removal of water from the location in the first volume.

Preferably, the apparatus further comprises a pressure reducing device for reducing the pressure in the second volume relative to the first volume.

According to a third aspect of the present invention, there is provided a method of de-watering flocculated material, comprising the steps of:
providing an apparatus comprising a vessel having a first volume and a second volume being separated by a filter means, the filter means being configured to allow water to pass through and to retain solids;
providing a pressure application means configured, in use, to apply a reduced pressure from a location in the first volume spaced from the filter means, the pressure application means being provided with a fluid connection for removal of water from the location in the first volume;
introducing flocculated material into the first volume to form a layer over the filter means; and
producing a pressure difference in the pressure application means between the second volume and the first volume to remove water from the first volume, so that water is removed from the flocculated material.

Preferably, producing the pressure difference corresponds to reducing the pressure in the pressure application means and second volume relative to the first volume to remove water from the first volume, so that water is removed from the flocculated material.

Preferably, the method includes producing the pressure difference using pressure reducing means.

The inventor has discovered that, surprisingly, when slurry which contains dissolved nutrients, such as nitrates and/or phosphates, is subjected to a flocculating process and the separated floccules are dewatered using the method of the invention, the nutrients are removed from the water phase, a substantial proportion of the nutrients being retained in the dewatered floccules.

Accordingly, in a fourth aspect of the present invention, there is provided a method for removal of nitrates and/or phosphates from a slurry, comprising the steps of:
flocculating solids in the slurry;
separating flocculated solids;
de-watering the solids using the method of the third aspect of the invention.

Preferred and optional features of the present invention are described below.

The inventor has realised that the effective depth of penetration of the reduced pressure can be increased by providing pressure application means extending into the mass of the flocculated material in the first volume, to a position remote from the filter means.

The pressure application means may then be connected to pressure reducing means so that water is drawn out of the flocculated material. However, in a preferred construction, the pressure application means may be used without pressure reducing means. The dynamic pressure head of the water within the flocculated material may serve to provide a pressure differential at the pressure application means where the pressure in the second volume is reduced relative to the pressure in the first volume. In this way, water may be removed without additional pressure reducing means. The water may also be drawn from the first volume by capillary action.

In an alternative construction, pressure increasing means may be provided or used to increase the pressure in the first volume relative to the second volume.

Where provided, the pressure reducing means may be a separate pressure reducing means, but is suitably the same as the pressure reducing means for reducing the pressure in the second volume. It is particularly preferred that the pressure application means is fluidly connected to the second volume. The pressure reducing means may include any form of suitable pump. A pump may also be provided connected to the pressure application means or any part of a circuit to which the pressure application means is attached to remove water which has been removed from the first volume.

In a preferred construction, the pressure application means is placed on the filter means, for example a filter, so that the pressure reducing means of the second volume acts on the pressure application means through the filter means. The filter means could be any type of suitable filter such as a porous membrane, rubber fibrous material, or geotextile material which retains solid, but allows water to pass. To prevent damage to the filter means, for example by the weight of any material introduced into the first volume, a protective structure, for example in the form of an expanded metal mesh may be provided over the filter means. A geosynthetic material may be provided between the filter means and the protective structure to prevent damage to the filter means. The filter means may be held in position to form the first volume by a support structure, which may also be an expanded metal mesh. In an alternative construction, perforated materials, e.g. perforated metal metals may be used in place of the expanded metal. To clean the vessel and the filter means, high pressure/low volume power washers may be used. By choosing suitable sized perforations, when cleaning, the filter means is protected from the penetrating spray of high pressure washers. Using low volume flow rates, the amount of wash water that needs to be re-processed is reduced.

The vessel may be a cargo container. The support structure may be supported on spaced pillars located on the base of the vessel.

The filter means may be substantially planar. The support structure and the protective structure may also be substantially planar. The form of the vessel and its parts may however be chosen to facilitate the introduction and/or removal of material into the first volume. The vessel may be cuboid or may be any other suitable shape.

In a preferred construction, the pressure application means is configured to provide a reduced pressure from a plurality of locations in the first volume spaced from the filter means. In this way, the de-watering effect can take place at a number of locations within the first volume.

In a preferred construction, the pressure application means preferably comprises a porous body and/or preferably includes a plurality of perforations in its surface. The reduced pressure may therefore be applied in close proximity to the material in the first volume. The perforations could be provided at locations where the reduced pressure produced from the filter means does not extend sufficiently. The perforations could be located to produce a reduced pressure zone which overlaps with that from the filter means or with other reduced pressure zones of the pressure application means.

The perforations may be provided spaced substantially over the entire surface of the pressure application means. The pressure application means may therefore be effective over its entire surface or a substantial proportion thereof. The reduced pressure may also be applied evenly over the surface of the pressure application means and therefore through the volume of material in which the pressure application means is located in use.

The perforations may be formed as holes and/or slits. The arrangement and configuration of the perforations may be chosen to produce an effective zone of reduced pressure. The perforations could be located and configured to ensure an overlap of the reduced pressure zones. The perforations could be formed in any suitable manner to provide a reduced pressure and remove water.

In a preferred construction, the pressure application means comprises a duct, tube or other hollow structure. Such a structure facilitates the provision of the reduced pressure within the first volume and also the removal of water from the location in the first volume. The pressure application means may be formed of any suitable material, for example, synthetic materials such as thermoplastic, composite material or metal, such as steel.

In a preferred construction, the pressure application means comprises a hollow elongate part. The elongate part may be straight and located to extend generally perpendicular to the plane of the filter means. The pressure application means could be formed as right-angle members, with perforations only provided in a part thereof. Alternatively, the pressure application means could be formed as any suitable shape, for example a coil or spiral.

In a preferred construction, the pressure application means comprises a pair of hollow elongate parts. Either or both of the elongate parts may be open at one end to allow the pressure reducing means to act therethrough. The pair of elongate parts may be arranged parallel to one another. The elongate parts may be of substantially equal length to form a ladder type arrangement. The elongate parts may be closed at their ends distal the filter means. Alternatively, the distal ends of the elongate parts may be connected to a reduced pressure source, or pressure reduction means. In this case, the ends proximate the filter means need not be open or work through the filter means.

Preferably, the pressure application means comprises one or more spaced hollow cross-member parts fluidly connected with said hollow elongate parts. The hollow cross-member parts may serve to provide structural support to the pressure application means. The cross-member parts may also serve to extend the range of the reduced pressure applied by the pressure application means in a direction substantially parallel with the plane of the filter means. The cross-member parts may also be provided with perforations to further extend the points of application of the reduced pressure in the first volume.

In a preferred construction, the hollow elongate parts are formed as tubes or pipes. Standard pipes and tubes may therefore be used to form the basis of the pressure application means. The cross-section of the hollow parts may be circular in form or square for example. The cross-section may be chosen to provide stiffness to the pressure application means. Other cross-sectional shapes may also be used, for example square, rectangular or oval.

In a preferred construction, each cross-member comprises a generally straight part, extending substantially perpendicular from each elongate part. A ladder type form is therefore provided. In an alternative construction, each cross-member part comprises two angled parts, each part extending from each elongate part at an angle thereto. Such a construction may serve to increase the total surface area of the cross-section parts between the elongate parts such that when they are perforated, a greater range of reduced pressure may be applied to the first volume. Preferably, the angle is less than 90 degrees. The cross-member parts could alternatively be curved in form.

In an alternative construction, the pressure application means may be formed of perforated panels to form hollow structures. In a preferred construction, the pressure application means comprises a pair of spaced generally rectangular perforated panels, which define a volume, in use, fluidly connected to the second volume. The panels are preferably orientated substantially perpendicular to the base of the first volume. A matrix of pressure application means may be provided in the first volume, for example in two rows.

The pressure application means may be rigid. Alternatively, the pressure application means may be flexible. Whether the pressure application means is flexible or rigid may depend on how the flocculated material is introduced and removed from the first volume. A flexible or semi-flexible structure may avoid damage by excavating means used to remove the dewatered material. A rigid structure may serve to prevent constriction of the pressure application means and a reduction in the reduced pressure that may be applied or the water that may be removed.

Preferably the perforations are covered with a filtering means. The filtering means may be a grid, grate, mesh or any other suitable material. The filtering means may seek to prevent the ingress of debris into the pressure application means via the perforations to seek to prevent any degradation in the reduced pressure that may be applied and the ability of the pressure application means to remove water. The pressure application means could alternatively be formed of a material in which the perforations are formed and configured to prevent the ingress of debris and thus no further filtering means may be required.

In a preferred construction, the pressure application means includes a support means to maintain the pressure application means in a stable position. The support means could include a base. Alternatively, support legs, for example camel leg supports, could be provided to maintain the pressure application in a suitable location and position. The support means could include means to rigidly fix the pressure application means to the filter means or any structure within the first volume. Such means could include welding or adhesives or other mechanical means such as bolts. However, it is preferable that the pressure application means be removably supported in the first volume, so that it can be removed for cleaning and/or emptying of the first volume. The support means could include means to hang or suspend the pressure application means from above.

In an alternative construction, the pressure application means may be formed integrally with the vessel. The pressure application means may comprise a number of telescopic parts, for example, tubing or channel iron, configured to allow retraction of the pressure application means away from the centre of the first volume. The telescopic parts may be provided with releasable engaging means, to engage and lock the retracted telescopic parts in position. The retraction of the pressure application means facilitates excavation of dewatered flocculated material from the vessel. Once the material has been removed, the pressure application means may be reintroduced into the vessel.

In a preferred construction, the vessel may be provided with a closable opening in the first volume of the vessel. This opening may permit material to be inserted and removed from the first volume. The vessel may be tiltable to facilitate removal of material by tilting the vessel such that it may flow out of the closable opening. Hydraulic rams may be used to tilt the vessel so that the dewatered material may flow or slide out of the first volume.

Moveable means may be provided in the first volume, for displacing material through the opening. The moveable means may include a displaceable plate for pushing the material out of the first volume.

A standpipe may be provided in the first volume to vent, in use, air trapped within said flocculated material. The standpipe may be provided with valve means, for example a check valve, to close the standpipe when a reduced pressure is provided in the second volume relative to the first volume.

A plurality of pressure application means may be provided in the first volume. Each pressure application means may be formed identically or a variety of different structures may be used. Each pressure application means may include one or all of the features described. The number and type of pressure application means may be chosen to provide a matrix of reduced pressure zones within the first volume. In this way, the reduced pressure zones or radii may extend substantially throughout the first volume and therefore in use throughout the material introduced. The pressure application means may be arranged in an evenly spaced arrangement. The pressure application means may be located away from the edges of the first volume so that the reduced pressure zone extends up to the edge.

In a preferred construction, the pressure application means are arranged to extend generally perpendicular to the plane of the filter means. Alternatively, the pressure application means may be arranged to extend parallel with the plane of the filter means. Other arrangements may also be used in order to apply the reduced pressure throughout or to particular areas of the first volume. The pressure application means may be positioned within the first volume away from the peripheral sides of the first volume. Preferably, the pressure application means are positioned at least 50 cm from the edges of the vessel and preferably around 100 cm from each other.

In a preferred construction, a filter means may be provided adjacent the side walls of the first volume. The filter means may comprise a protective metal structure. Preferably, the structure is formed of perforated panels spaced from the side walls and substantially parallel thereto. In this way an additional hollow structure may be provided.

Behind the structure at the side walls, a filter medium may be provided. Preferably, the filter medium is rubber fibrous material. A geosynthetic material may be provided between the filter medium and the metal structure. The side panels preferably extend only partially up the side walls. The hollow structure behind the filter medium may be fluidly connected to the second volume.

The vessel may be provided with a cover, for example in the form of a manifold. The cover may be a plate to place over the vessel or the material introduced therein in order to prevent pressure loss. Lifting means such as hooks may be provided on the manifold to aid removal thereof. The pressure application means may be attached to said manifold and thereby removable when the manifold is removed.

Once the de-watering process is complete, the vessel may be emptied, for example, using an excavator. Clear water removed from the flocculated material may be returned to a rapid dewatering system. If suitable filter means are used, a clarity of 20 mg/litre or less may be achieved.

In a preferred constructions, the material in the vessel forms a sludge bed, which may serve to reduce the volume of contaminants, including nutrients, such that the water removed may be more easily treated prior to discharge from the system. The nutrients removed may include phosphorous and nitrogen

The present invention will now be described by way of example, by reference to the accompanying drawings, in which:

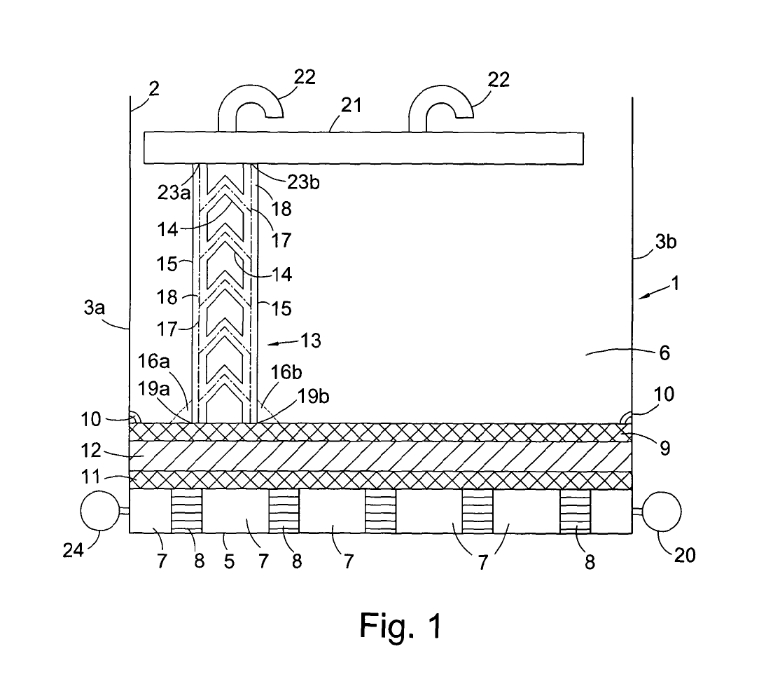

FIG. 1 shows a side view of an embodiment of the present invention;

FIG. 2 shows an isometric view of an embodiment of the present invention;

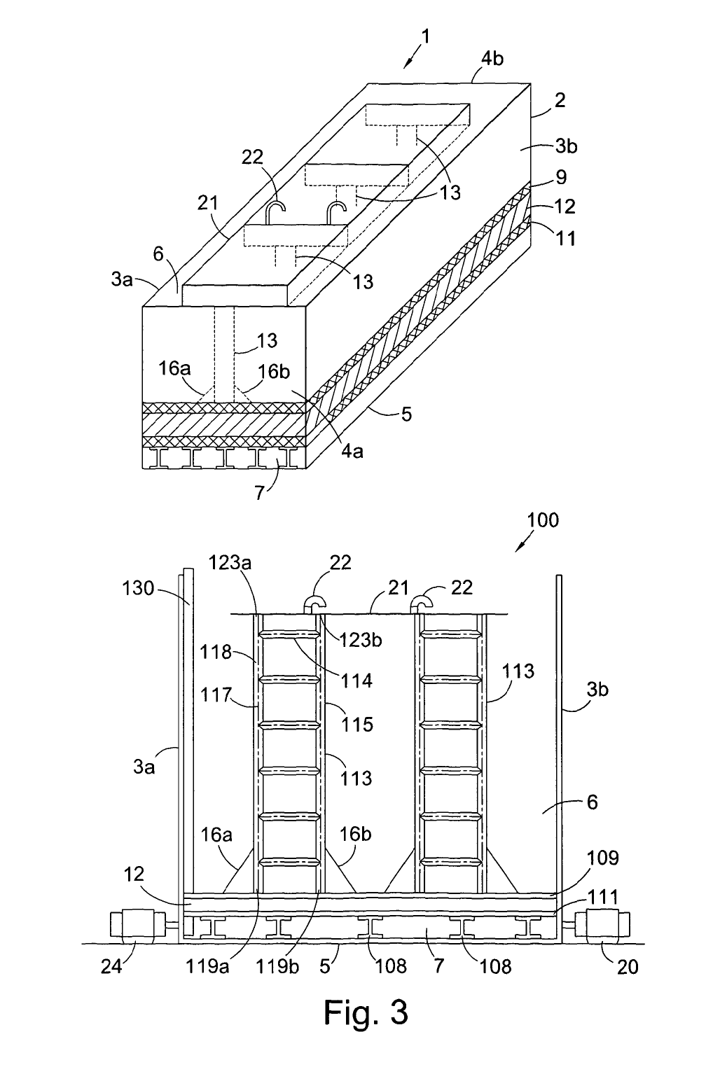

FIG. 3 shows a side view of a further embodiment of the present invention;

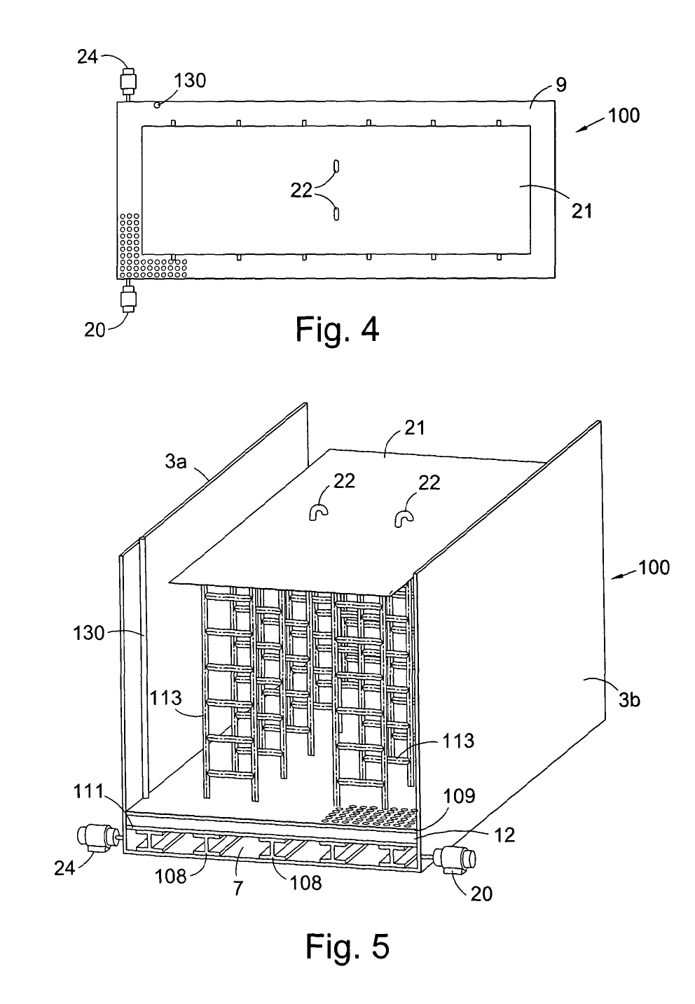

FIG. 4 shows an top view of the embodiment of FIG. 3;

FIG. 5 shows an isometric view of the embodiment of FIG. 3; and

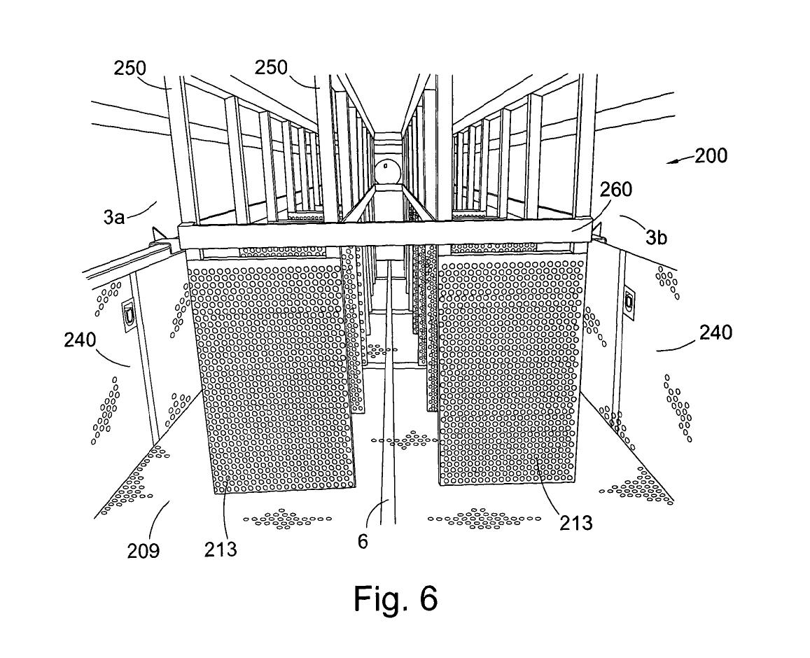

FIG. 6 shows an end view of a further embodiment of the present invention.

Although dimensions may be shown in the drawings, the present invention is not limited to these and may be scaled depending on the particular application. The dimensions may however show preferred proportional relationships between the features.

FIG. 1 shows an embodiment of the present invention indicated generally at 1.

The present invention may be used to dewater flocculated material obtained by the process and apparatus shown in WO2007/093809. The apparatus may be used in place of the apparatus shown in FIGS. 8 and 9 of that document. However, it may be used in conjunction with other apparatus, for example a clarifier.

The system shown comprises a substantially open cuboid vessel in the form of a container 2 defined by substantially planar side walls 3a, 3b, end walls 4a, 4b and base wall 5. In the embodiment shown, the container 2 is a cargo container.

The base wall 5 is provided with a series of spaced support pillars 8. The support pillars 8 support an expanded metal support structure 11 in a generally horizontal plane. Embodiments are envisaged in which the expanded metal support structure is in the form of a metal lattice framework, mesh or other suitable structure.

A protective expanded metal structure 9 is provided spaced above the support structure 11 in a generally horizontal plane and substantially parallel thereto. The protective expanded metal structure 9. In preferred embodiment, the metal structure is formed of a metal lattice framework, mesh or other suitable structure. The protective metal structure 9 is located above the support structure 11 by fixing means 10 which fix the protective expanded metal structure 9 around its peripheral edge to the side walls 3a, 3b and end walls 4a, 4b. In preferred embodiments, the fixing means include bolts or spot welds or any other suitable connection.

A filter means 12 or filter medium, for example a porous medium in the form of a rubber woven geotextile material, is provided between the protective structure 9 and the support structure 11.

A first volume 6 defined by the protective structure 9, the side walls 3a, 3b and end walls 4a, 4b, provides a volume into which flocculated material may be introduced.

A second volume 7 is provided defined by the side walls 3a, 3b, end walls 4a, 4b, the base wall 5 and the expanded metal support structure 11. The support pillars 8 are arranged to allow fluid or air to flow freely within the second volume 7.

The porous medium 12 serves to prevent the flocculated material or de-watered flocculated material passing from the first volume 6 to the second volume 7. The porosity of the porous medium 12 is however chosen such that water may pass from the first volume 6 to the second volume 7.

The protective structure 9 serves to prevent undue loading on the porous media 12 and thereby maintain its integrity and porosity. The protective structure is chosen to support the weight of a flocculated material, for example in the form of a sludge.

A pressure application means in the form of a structure 13 is provided in the first volume 6. In the embodiment shown, the structure 13 is orientated generally vertically, perpendicular to the plane of the protective structure 9 and filter medium 12. The structure 13 comprises a pair of elongate parts 15. In preferred embodiments, these elongate parts 15 are in the form of hollow tubes or pipes. In preferred embodiments, the tubes have a circular cross-section or any other suitable cross-section.

Between the elongate parts, a series of spaced cross-member parts 14 are provided. In the embodiment shown, the cross-member parts 14 comprise angled parts which extend from each elongate part, at an angle thereto, such that the angled parts meet at a point midway between the elongate parts 15 but in a plane above the plane of connection of the cross-member parts 14 with the elongate parts 15. Such a structure serves to increase the surface area of the cross-member parts 14. In the embodiment shown, a ladder like structure is thereby formed.

In alternative preferred embodiments, the pressure application means are formed as arrays of tubes or other suitable arrangement to provide means of applying, in use, a pressure at a location spaced from the filter means. In preferred embodiments, the pressure application means are rigid or alternatively flexible.

The cross-members 14 in the embodiment are formed of hollow tubular parts.

To support the structure 13, support means, for example in the form of legs 16a, 16b are provided to maintain the structure 13 in a generally vertical orientation. The structure 13 may also be fixedly connected to the protective structure 9 or hung from its end distal its base.

The internal volumes of the elongate parts 15 and the cross-member parts 14 are fluidly connected.

The elongate parts 15 and the cross-members parts 14 are provided with a plurality of perforations, for example in the form of slits 17 and/or holes 18, which extend into their internal volume. In the embodiment shown, a combination of holes 18 and slits 17 are provided in series. The size of the perforations may be chosen to prevent flocculated material or dewatered flocculated material passing therethrough but permit the passing of water. The perforations may be provided spaced over substantially the whole surface of the structure 13. A membrane or other filtering means, for example a fabric material, may be used to cover the perforations such that the perforations do not become blocked by the ingress of particulate matter.

The ends 19a, 19b of the structure 13 which are proximate to the protective structure 9 are open and sit on top of the filter medium 12. The ends 23a, 23b of the structure 13, positioned in use furthest from the protective structure 9 may be fully closed. Alternatively, the ends may comprise similar perforations to the perforations provided in the elongate parts 15 and cross-member parts 14.

In use, flocculated material, for example in the form of a sludge is introduced into the first volume 6 of the container 2. The flocculated material is introduced into the first volume 6 of the chamber 2 to form a complete layer over the protective structure 9.

The flocculated material is of a thixotropic nature such that the material forms a layer over the protective structure 9 which does not allow air to pass through.

A vacuum pump 20 is connected to the second volume 7. The vacuum pump serves to remove air from the second volume 7 and thereby reduce the pressure in the second volume 7 relative to the first volume 6. Even without the vacuum pump attached, the dynamic head of water of the flocculated material may provide a sufficient pressure differential between the first volume and the second volume. The vacuum pump is not switched on until a complete layer has been produced over the protective structure 9. It is also preferable that the perforations in the structure 13 are covered by the introduced flocculated material.

When a complete layer has been formed which covers the perforations in the structure 13, the vacuum pump 20 is then switched on, thereby reducing the pressure in the second volume 7 relative to the first volume 6.

Because the ends 19a, 19b of the elongate parts 15 sit on the filter medium 12, the internal volume of the structure 13 is fluidly connected through the filter medium 12 to the second volume 7. Accordingly, as the pump 20 reduces the pressure in the second volume 7 relative to the first volume, or the dynamic head of water is higher than the pressure in the second volume, the pressure throughout the internal volume of the structure 13 is also reduced and therefore a reduced pressure or vacuum is applied from a location spaced from the filter medium. In this way, the structure 13 provides a pressure application means. A de-watering zone or radius is thereby produced by the reduced pressure or vacuum at each of the perforations. The internal volume of the structure 13 provides a fluid connection to remove water from the first volume 6.

Depending on the type of flocculated material and the vacuum pressure applied by the pump 20, the influence of the reduced pressure or vacuum extends into the flocculated material from each of the perforations. Typically a vacuum may extend up to 50 cm into the flocculated material from each perforation.

Because the internal volume of the pressure application means 13 is kept clear of flocculated material, the perforations only permitting the flow of water, the influence of the vacuum from each perforation has minimal degradation along the length of the structure 13.

The resultant pressure differential serves to draw free-water from the flocculated material through the perforations of the pressure application means 13. The water is, in turn, drawn through the protective structure 6, the filter medium 12 and the support structure 11 to the second volume 7. Other forces such as capillary action may be assist in drawing the water to the second volume. In the embodiment shown, free-water is also drawn directly through the protective structure 6, the filter medium 12 and the support structure 11 to the second volume 7.

It is also envisaged that the pressure application means may be connected to an alternative outlet than the second volume 7. It is also envisaged that the pressure application means could be used as the only means of de-watering the flocculated material.

When a safe water level is reached in the second volume 7, e.g. sufficient to prime a pump, the water drawn from the flocculated material may be pumped from the second volume 7 using a water pump 24.

Once the flocculated material has been sufficiently de-watered, the vacuum pump 20 and water pump 24 are switched off. The de-watered flocculated material may then be removed from the container 2. In a preferred embodiment (not shown), the vessel includes a closable opening, e.g. a swing door, to allow flocculated material to be removed. In a preferred embodiment, the vessel is tiltable to facilitate the removal of the material through the closable opening. In a preferred embodiment, a displaceable plate is provided to displace, e.g. by pushing, the material. The free water removed from the flocculated material may, for example, be further treated and/or discharged back into a waterway or industrial circuit.

A substantially planar manifold plate 21 is provided on top of the flocculated material in the first volume 6. This manifold plate 21 serves to reduce vacuum loss in the case of cracks and fissures that may be produced in the de-watered flocculated material. Attachment means, for example in the form of hooks 22 are provided on the manifold 21 in order to allow the manifold 21 to be removed from the container 2. In a preferred embodiment, the pressure application means are formed integrally with the vessel, for example the manifold plate. In a preferred embodiment, the pressure application means may be formed with telescopic parts such that they can be retracted to facilitate their removal from the flocculated material.

FIG. 2 shows an isometric view of a de-watering apparatus. A plurality of pressure application means in the form of structures 13 are provided at spaced intervals along the length and also the width of the first volume 6. An arrangement of the structures 13 may be chosen to provide an overlap of the de-watering zones or radii in both vertical and horizontal planes throughout the flocculated material. In this way, the vacuum which normally only has influence in the region of the filter medium 12 may be extended throughout substantially the entire depth and therefore volume of the flocculated material.

In the embodiment of FIG. 1, a structure 13 may be placed around 50 cm (18 inches) from the side wall 3a, 3b or end wall 4a, 4b such that the reduced pressure or vacuum produced in the structure 13 has influence in the region up to the side wall 3a, 3b or end wall 4a, 4b.

In the system as shown in FIG. 2, the container 2 has dimensions of around 12 metres (40 feet) along its length between end walls 4a, 4b. The container 2 has a width of around 2.5 metres (8 feet) between the side walls 3a, 3b. The height of the container is around 2.5 metres (8 feet) high. Of this height, the first volume 6 has a height of around 2 metres (6.5 feet) from the top of the protective structure 9 and the open top of the container 2 and a height of around 0.5 metres (1.5 feet) from the base wall 5 to the protective structure 6.

In the embodiment shown in FIG. 2, a series of four structures 13 are provided spaced along the length of the container 2.

As the structure 13 may provide a reduced pressure or vacuum influence throughout an increased depth of flocculated material, a greater depth of flocculated material may be dewatered in the first volume 6. In this way, the footprint of the system compared with conventional shallow depth vacuum bed systems, where for example de-watering of a depth of less than 1 metre (2-3 feet) may be expected in a 24 hour period. The depth and therefore capacity of such a system is only then limited by the means to remove the de-watered flocculated material from the container 2. The system may also provide increased de-watering rates.

FIG. 3 shows a side view of a further embodiment of the present invention. The system shown generally at 100 is formed similarly to the system of FIGS. 1 and 2 and the description of the identical features, which have been allocated identical reference numerals, will not be repeated here.

In contrast to the system of FIG. 1, the system of FIG. 3 includes spaced supports 108 on the base wall 2 in the form of I-beams, which support a perforated metal support structure 111 in a generally horizontal plane.

A protective structure 109 is provided over the filter means 12. The protective structure 109 is formed of perforated metal or any other suitable structure.

A pressure application means in the form of a structure 113 is provided in the first volume 6. In the embodiment shown, the structure 113 is orientated generally vertically, perpendicular to the plane of the protective structure 109 and filter medium 12. The structure 113 comprises a pair of elongate parts 115. These elongate parts 115 may be in the form of hollow tubes or pipes. The tubes may have a circular cross-section or any other suitable cross-section.

Between the elongate parts 115, a series of spaced cross-member parts 114 are provided. In the embodiment shown, the cross-member parts 14 are straight parts which extend perpendicularly from the elongate parts 115.

The elongate parts 115 and the cross-members parts 114 are provided with a plurality of perforations, for example in the form of slits 117 and/or holes 118, which extend into their internal volume. In the embodiment shown, a combination of holes 118 and slits 117 are provided in series. The size of the perforations may be chosen to prevent flocculated material or dewatered flocculated material passing therethrough but permit the passing of water. The perforations may be provided spaced over substantially the whole surface of the structure 113. A membrane or other filtering means, for example a fabric material, may be used to cover the perforations such that the perforations do not become blocked by the ingress of particulate matter.

The ends 119a, 119b of the structure 113 which are proximate to the protective structure 109 are open and sit on top of the filter medium 12. The ends 123a, 123b of the structure 113, positioned in use furthest from the protective structure 109 may be fully closed. Alternatively, the ends may comprise similar perforations to the perforations provided in the elongate parts 115 and cross-member parts 114.

A standpipe 130 is provided. The standpipe is used to allow trapped air to be vented from the flocculated material. The standpipe is provided with a check valve, which seals when the pressure in the second volume 7 is reduced relative to the pressure in the first volume 6.

FIG. 4 shows a plan view of the embodiment of FIG. 3. FIG. 5 shows an isometric view of the embodiment of FIG. 3. Perforations 135 in the protective structure 109 are shown representatively although these extend substantially across the whole of the surface of the structure 109. A series of structures 113 are provided spaced in two substantially parallel rows in the first volume 6.

FIG. 6 shows a side view of a further embodiment of the present invention. The system shown generally at 200 is formed similarly to the system of FIGS. 1 to 5 and the description of the identical features, which have been allocated identical reference numerals, will not be repeated here.

In contrast to the system of FIGS. 1 to 5, the system of FIG. 6 includes pressure application means 213 each comprising two spaced perforated panels. The panels are substantially rectangular and formed of perforated sheet metal. The panels are attached along each elongate side to a vertical support element 250. The panels define hollow structures. Although not shown in the Figure, a geosynthetic material may be provided over the perforated panels.

A plurality of similar pressure application means are provided in a matrix form, in the embodiment, in two rows of pressure application means 213. The support elements 250 form a metal frame with transverse members 260. The metal frame can be lifted to remove the pressure application means from the first volume. The support elements 250 may be formed of telescopic parts so as to facilitate retraction of the pressure application means.

A protective metal structure 209, in the embodiment perforated plate, is provided at the bottom of the first volume. Below the structure 209, a filter medium is provided, in the embodiment a rubber fibrous material. A geosynthetic material is provided between the filter medium and the metal structure 209. This material serves to protect the filter medium from high pressure cleaning jets, which are used to clean the system.

In the embodiment shown, adjacent each of the side walls 3a, 3b a similar structure to the base of the first volume is provided. This structure comprises a protective metal structure 240, in the embodiment perforated panels, which extend from the base wall substantially parallel to the side walls and spaced therefrom. Behind the structure 240, i.e. on the side away from the centre of the first volume, a filter medium is provided, in the embodiment a rubber fibrous material. A geosynthetic material is provided between the filter medium and the metal structure 240. The volume or hollow structure formed by the side panels 240 is fluidly connected to the second volume such that in use, when a pressure differential is present, e.g. a vacuum is applied in the second volume, water is drawn from flocculated material placed in the first volume 6. In use, flocculated material is introduced to cover the pressure application means and the side panels 240. The side panels 240 extend only partially up the side walls 3a, 3b so that when flocculated material is introduced into the first volume and water removed therefrom, if the flocculated material should shrink, any vacuum applied to the pressure application means is not lost through direct connection with the atmosphere.

Compared with belt press systems, the lack of moving parts seeks to improve reliability and facilitate simple operation.

Tests of the system have shown that nutrients such as phosphorous and nitrogen may be captured in the de-watering process such that they are retained in the de-watered material.

Although the present invention has been described in relation to de-watering flocculated material, it is envisaged that the invention may be applied to other de-watering and filtering processes.

1. Apparatus for de-watering flocculated material, the apparatus comprising:
a vessel having a first volume and a second volume being separated by a filter, the filter being configured to allow water to pass through and to retain solids;
the first volume being for receiving a flocculated material; and
a pressure application structure in the first volume configured to apply a reduced pressure from a location in the first volume that is spaced from the filter means, the pressure application structure being provided with a fluid connection for removal of water from the location in the first volume and pass the water to the second volume.

2. Apparatus according to claim 1, the apparatus further comprising:
a pump for reducing the pressure in the second volume relative to the first volume.

3. Apparatus according to claim 1, wherein the pressure application structure is fluidly connected to the second volume.

4. Apparatus according to claim 1, wherein the pressure application structure comprises a duct, tube, spaced panels or other hollow structure.

5. Apparatus according to claim 1, wherein the pressure application structure is configured to provide a reduced pressure from a plurality of locations in the first volume spaced from the filter.

6. Apparatus according to claim 1, wherein the pressure application structure includes a plurality of perforations in its surface.

7. Apparatus according to claim 6, wherein the perforations are provided spaced substantially over the entire surface of the pressure application structure.

8. Apparatus according to claim 7, wherein the perforations may be formed as holes and/or slits.

9. Apparatus according to claim 1, wherein the pressure application structure comprises a hollow elongate part.

10. (canceled)

11. Apparatus according to claim 9, the apparatus comprising a pair of hollow elongated parts and wherein the pressure application structure comprise one or more spaced hollow cross-member parts fluidly connected with said pair of hollow elongate parts.

12. Apparatus according to claim 9, wherein the hollow elongate part is formed as a tube or a pipe.

13. Apparatus according to claim 9, wherein the each cross-member part comprises a straight part, extending substantially perpendicular from each elongate part.

14. Apparatus according to claim 11, wherein the each cross-member part comprises two angled parts, each part extending from each elongate part at an angle thereto.

15. Apparatus according to claim 14, wherein the angle is less than 90°.

16. Apparatus according to claim 1, wherein the pressure application structure is rigid.

17. Apparatus according to claim 6, wherein the perforations are covered with a second filter.

18. Apparatus according to claim 1, wherein the pressure application structure includes a support to maintain the pressure application structure in a stable position.

19. Apparatus according to claim 1, wherein the vessel is provided with a plurality of pressure application structures

20. (canceled)

21. Apparatus according to claim 1, wherein the pressure application structure extends, generally perpendicular to the plane of the filter.

22. Apparatus according to claim 19, wherein the pressure application structures are arranged to provide zones of reduced pressure throughout the first volume.

23. Apparatus according to claim 1, wherein the pressure application structure comprise a number of telescopic parts configured to allow retraction of the pressure application structure away from the centre of the first volume.

24. Apparatus according to claim 1, wherein the vessel is provided with a cover configured to cover flocculated material in said first volume.

25-27. (canceled)

28. Apparatus according to claim 26, wherein a moveable structure is provided in the first volume for displacing material through said opening.

29. Apparatus according to claim 1, further comprising a standpipe in the first volume configured to vent air within said flocculated material.

30. Apparatus for de-watering flocculated material, the apparatus comprising:
a vessel having a first volume and a second volume being separated by a filter, the filter being configured to allow water to pass through and to retain solids;
the first volume being for receiving flocculated material; and
a duct configured to apply a reduced pressure from a location in the first volume that is spaced from the filter, the duct being provided with a fluid connection for removal of water from the location in the first volume and pass the water to the second volume.

31. (canceled)

32. A method of de-watering flocculated material, comprising the steps of:
providing an apparatus comprising a vessel having a first volume and a second volume being separated by a filter, the filter being configured to allow water to pass through and to retain solids;
providing a pressure application structure in the first volume configured to apply a reduced pressure from a location in the first volume that is spaced from the filter, the pressure application structure being provided with a fluid connection for removal of water from the location in the first volume and pass the water to the second volume;
introducing flocculated material into the first volume to form a layer over the filter; and
producing a pressure difference in the pressure application and pass the water to the second volume between the second volume and the first volume to remove water from the first volume, so that water is removed from the flocculated material.

33-38. (canceled)
